(19) United States
(12) Patent Application Publication
(10) Pub. No.: US 2003/0144044 A1
(43) Pub. Date: Jul. 31, 2003

(54) Game-specific standard-task automation for computer and console video games

(75) Inventor: Vladimir R. Pisarsky, Sunnyvale, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/066,110

(22) Filed: Jan. 31, 2002

(51) Int. Cl. A63F 13/00

(52) U.S. Cl. 463/1

(57) ABSTRACT

A video game comprises several parts that require attention and response from the user. Interaction with a part that allows for an algorithmic solution can be delegated to a separate controller, thus freeing bandwidth for the user to concentrate on other parts so as to optimize the score.

### FIELD OF THE INVENTION

The invention relates to electronic games, such as video games.

### BACKGROUND ART AND SUMMARY OF THE INVENTION

The growing popularity of video games has led to changes in their perceived value. Originally marketed as games for entertaining children, video games have become a significant part of the entertainment industry and spectator sport for all kinds of audiences and participants. The upcoming market of on-line multi-player games has created a social and sport environment with international championship contests in selected games, and heavily involving the advertisement industry and secondary markets. On-line “clans” and “clubs”-teams of gamers include tens of thousands of players worldwide. Many of these participants are very willing to invest time and money in increasing their game ratings.

Most games include standard positions and standard situations: repeating elements for which a clear and simple algorithm exists in order to deal with them. This is true for most arcade, strategy and role-playing games. See, for example, hitting a target in a ship-to-ship battle in Microsoft's “Age of Empires” or selecting the optimal speed to round a corner or drift through a curve in a simulated car or motorcycle race.

A successful accomplishment of such standard tasks requires a precise implementation of the optimal algorithm and peak concentration from the player (for a few hours), or some calculations. Both of these tasks can be easily performed by a computer. For a human being, however, these tasks represent sources of mistakes that prevent the player from reaching a top achievement in the game.

The inventor therefore proposes to delegate the standard tasks, with clear optimization algorithms, to a special computational unit that is preferably separate from the prime game platform (e.g., PC or game console). Such a game “aid” provides a game-specific optimization, and auto-immunization, in order to help the user to achieve top results.

The game “aid” frees bandwidth for the user to concentrate on other than standard tasks such as handling strategic issues. Preferably, the game “aid” has a direct input/output to and from the main platform that allows for analysis of the current game situation without the need for the intervention of the player. Preferably, the game “aid” is implemented as being specific to the game to allow to apply automation to a wide spectrum of situations.

Accordingly, the invention relates to the automation of standard game situations that allow algorithmic solutions by the usage of a special computational unit, separate from the main game platform, or a plug-in component to the platform.

Alternatively, a second player can get involved through a dedicated user interface that enables him/her to handle one or more standard tasks, while the first player dedicates his/her attention to the other, non-standard tasks.

The means to enable to delegate handling part of the electronic game to an entity other than the user can be marketed as an upgrade or can be provided to players once they have achieved a skills threshold as represented by, e.g., their individual score.

More generally, an implementation of the invention relates to a method of enabling a user to interact with an electronic game. The game has first and second interactive components for receiving input from the user. The method comprises enabling to delegate interaction with the first component to an entity other than the user, e.g., to an autonomous process for execution of an algorithm representing the interaction with the first component, or to a second user. Preferably, the user can select whether or not to delegate the interaction with the first component to the other entity.

Another implementation of the invention also relates to a data processing system for playing an electronic game, wherein the game has first and second interactive components for receiving input from a user. The system comprises a module that enables to delegate interaction with the first component to an entity other than the user. The module can be a separate hardware unit or a plug-in software component. The module comprises, for example, a controller for autonomous interaction with the first component, or a user interface for enabling a second user to interact with the second component. Preferably, the system allows the user to selectively delegate the interaction with the first component.

Another implementation of the invention relates to a module for use with a data processing system for playing an electronic game. The game has first and second interactive components for receiving input from a user. The module enables to delegate interaction with the first component to an entity other than the user. The module can be a hardware component to be connected to the system, or a software plug-in. The module comprises, e.g., a controller for autonomous interaction with the first component, e.g., using an algorithmic approach. Alternatively, or in addition, the module comprises a user interface for enabling a second user to interact with the first component. Preferably, the module or the system or the game itself comprises a selector for enabling the user to selectively delegate the interaction with the first component.

Yet another implementation of the invention relates to an electronic interactive game with first and second components for receiving input from a user. The game is configured to have interaction with the first component delegated to an entity other than the user. For example, the interaction with the first component allows for automated algorithmic execution, and an algorithm is supplied for this particular component.

For the sake of completeness, automatization means within the context of computer-related environments are known: targeting computers are being used in the military; auto pilot units (for airplanes) and cruise control (for automobiles); joysticks with “rapid fire” features (i.e., ability to simulate a multiple input from a “fire” button.

### BRIEF DESCRIPTION OF THE DRAWING

The invention is explained in further detail, by way of example, with reference to the accompanying drawing, wherein:

FIG. 1 is a block diagram of a prime configuration of a gaming system; and

FIG. 2 is a block diagram of the configuration of a gaming system with a game aid of the invention.

Throughout the drawing, same reference numerals indicate similar or corresponding aspects.

### DETAILED DESCRIPTION OF THE EMBODIMENTS

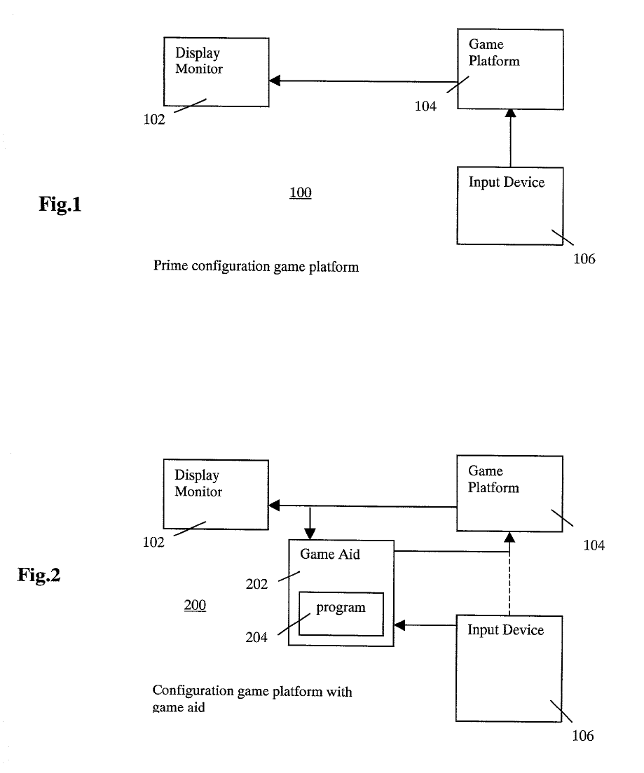

FIG. 1 is a block diagram of a basic configuration of a game system 100. System comprises a display monitor 102, e.g., a PC monitor or TV monitor; a game platform 104, e.g., a game console or a PC or a distributed data processing system, and an input device 106, e.g., a joystick, a keyboard or another specific user-interface (UI). A player interacts with the game running on platform 104 using device106 for input and monitor 102 for visual and audio feedback.

The game typically has several semantic components that require concentration, skill and fast response from the user, e.g., identifying possible targets, choosing the proper targets, taking them out, guiding a vehicle along the optimal path, checking for danger or obstacles, etc., etc. Some of these components can be handled automatically by the system if they are solved through an algorithmic approach. These components are referred to herein as standard tasks. A standard task may reside more at the tactical level, whereas a non-standard task may be residing more at the strategic level, for example. In the current set-up of system 100, the user has to divide time and attention between standard tasks and non-standard tasks.

FIG. 2 is a block diagram of the configuration of a game system 200 comprising components 102-106 and a game aid 202 according to the invention. Game aid 202 receives input from game platform 104 so as to have the information of the current state and stage of development of the game. Preferably, game aid 202 also receives input from input device 106 so as to get information about the current response of the player. The game's current state and the player's current response represent information that is to be taken into account as, e.g., the boundary conditions under which to solve the standard tasks in an automated way using the algorithmic approach.

Game aid 202 is, e.g., a separate module that can be connected to system 100, or a plug-in that runs on platform 104 and that can be activated selectively, or a unit that can be physically integrated with input device 106, etc. Game aid 202 or another part of system 200 has a selector (not shown) to allow the user or another agent to selectively enable the game aid as a functional part of system 200. The selector can be operated manually or through other direct user-input, or can be activated through the system upon a certain event, e.g., reaching a certain score level or after a certain period of time, etc. As the rules of a game are known in advance, certain semantic components can be identified and labeled in advance as belonging to the class of standard-components. A dedicated game aid 202 is programmed with certain instructions or programs 204 that match the specific game. More specifically, what the user perceives on monitor 102 is the rendered data generated under control of the game platform. The data represent the visual or auditory cues to which the user can respond via device 106. Accordingly, the semantics of the data is known and is reflected by instructions or programs 204 that generate appropriate responses as if they came from the ideal user. Instructions 204 identify the standard components and take appropriate action by default by sending the appropriate data or signal to platform 104 as if it came from input device 106. Alternatively, the game aid can be taught or programmed to identify a specific standard component so as to take care of it in the automated way during operational use. In FIG. 2 input device 102 is shown to provide data to platform 104 via game aid 202, where game aid 202 merges the output data from program 204 with the output from device 106, the latter being manipulated by the user. Note that there is no need at all to change anything in the original game. That is, reconfiguration of the game or the presence of any switches inside the game is not required. The game aid simulates the input from a standard input device, e.g., a keyboard or another user-manipulated game controller and inserts the generated signals into the game's standard input.

Also note that the same game can be partitioned into first and second (and/or more) components in a variety of different manners. Accordingly, for the same game it is possible to have a whole spectrum of game aids, incrementally or complementarily, that can be marketed as individual upgrades. Alternatively, the game aid can be made re-programmable so that new or upgraded instructions can be downloaded from a server or otherwise entered into the game aid. A dedicated service on the Internet can be imagined to serve as a repository and source of pieces of code matching specific standard tasks in specific games.

What is claimed is:

1. A method of enabling a user to interact with an electronic game having first and second interactive components for receiving input from the user, wherein the method comprises enabling to delegate interaction with the first component to an entity other than the user.

2. The method of claim 1, wherein the enabling to delegate comprises enabling to perform the interaction with the first component through autonomous execution of an algorithm.

3. The method of claim 1, wherein the enabling to delegate comprises enabling a second user to interact with the first component.

4. The method of claim 1, comprising enabling the user to selectively delegate the interaction with the first component to the other entity.

5. A data processing system for playing an electronic game that has first and second interactive components for receiving input from a user, wherein the system comprises a module that enables to delegate interaction with the first component to an entity other than the user.

6. The system of claim 5, wherein the module comprises a controller for autonomous interaction with the first component.

7. The system of claim 5, wherein the module comprises a user interface for enabling a second user to interact with the second component.

8. The system of claim 5, enabling the user to selectively delegate the interaction with the first component.

9. A module for use with a data processing system for playing an electronic game, the game having first and second interactive components for receiving input from a user, wherein the module enables to delegate interaction with the first component to an entity other than the user.

10. The module of claim 9, comprising a controller for autonomous interaction with the first component.

11. The module of claim 9, comprising a user interface for enabling a second user to interact with the first component.

12. The module of claim 9, comprising a selector for enabling the user to selectively delegate the interaction with the first component.

13. An electronic interactive game having first and second components for receiving input from a user, wherein the game is configured to selectively delegate interaction with the first component to an entity other than the user.

14. The game of claim 13, wherein the interaction with the first component allows for automated algorithmic execution.
